(19) United States
(12) Patent Application Publication
(10) Pub. No.: US 2017/0227754 A1
(43) Pub. Date: Aug. 10, 2017

(54) SYSTEMS AND APPLICATIONS FOR GENERATING AUGMENTED REALITY IMAGES

(71) Applicant: YU HSUAN HUANG, Taipei (TW)

(72) Inventor: YU HSUAN HUANG, Taipei (TW)

(21) Appl. No.: 15/420,122

(22) Filed: Jan. 31, 2017

(30) Foreign Application Priority Data
Feb. 5, 2016 (TW) 105104114

(51) Int. Cl. G02B 21/36; G09B 19/00; H04N 13/04; G09B 5/02; G06F 3/01; G06T 19/00

(52) U.S. Cl. CPC G02B 21/367; G06F 3/017; G06F 3/011; G06T 19/006; H04N 13/044; G09B 5/02; G09B 19/00

(57) ABSTRACT

The systems and applications for generating the augmented reality (AR) images are disclosed. The system includes a processing module and a digital microscope module having a plurality of camera units, and the processing module tracks and parses the user's motions to generate the related control signals, the virtual objects composed to form the AR images according to the received instant images of the observed objects captured by the digital microscope module. Moreover, the processing module generates and outputs the AR images composing of the instant images and the user interface (UI), icons, objects, video and/or information related to the interactive applications while the display mode switch or the real-time tutorial and sharing is triggered.

### PRIORITY CLAIM AND RELATED APPLICATION

This application claims priority to TW Patent Application No. 105104114, entitled “SYSTEMS AND APPLICATIONS FOR GENERATING AUGMENTED REALITY IMAGES”, filed on Feb. 5, 2016.

### FIELD OF THE APPLICATION

The present application generally relates to the field of interaction systems and applications for an user and an observed object, and more particularly to a systems and applications for generating and operating the augmented reality (AR) images.

### BACKGROUND

Nowadays, the way to express the multimedia data through the stereo and dynamic augment reality (AR) images instead of the plat and static one is popular due to the higher processing ability of computer and the increasing demands on the visualization, straightforward operation, quality, response time and interaction. The AR technique is derived from that of the virtual reality (VR), and the major difference between them is that the VR creates the virtual environment or scenes and the virtual objects, whereas the AR creates and overlaps or composes the related virtual objects of real world's concrete or stereo objects into the images of the real world's environment or scenes and then displays on the whole. In other words, user can receive and realize the real-time response, information, and the operation result of the concrete or stereo objects in the real world's environment or scenes. Accordingly, developing more system and method of interactive application with lower latency and alignment error is a beneficial to the user.

Some known AR-based interactive applications adopt a marker-based, a markerless, an optical see-through based and a video see-through method for image processing. Specifically, a marker-based AR application detects the marker which can be recognized by the computer in the AR images and then retrieves and composes the AR contexts or information to the images of the real world's environment or scenes. However, the interaction and the applications are restricted due to the requirements such as the exact size, continuous boundary and specific pattern of the marker. On the other hand, a markerless AR application detects visually distinctive features distributed in the AR image, compares it with a preset static data stored in an feature database and then composes and display when they are matched. In general, the marker-based and the markerless method lack of the stereo effect to the dynamic or multimedia data.

The optical see-through method utilizes a translucent reflection mirror to exhibit the real world's and the virtual environment, images and objects, whereas the video see-through method composes the virtual images to the image sequence of the real world's environment captured by the camera. The disadvantage of using the former technique is that it has the alignment error and the display latency due to the asynchronous in the real and the virtual images during the display-timing, and the reduction of the illuminance resulted from the translucent reflection mirror. In the other hands, the disadvantage of using the latter technique is that it has the display latency when display the images to the user, although it has no alignment error and the display latency since it's synchronous during display-timing.

Moreover, for the user operating the traditional electronical or optical microscope, the disadvantage of using that is he/she shall move his/her head, eyes or hands away from the microscope for looking up some references from the book, manual or computer and recording the experimental results repeatedly, and the lacks of the interactive instructions or guidances in the forms of text, graphic, image or video stream, evaluating or sharing mechanism and the remote control may result in the inconvenience, inefficiency and interruption frequently. In addition, the lacks of supporting the operation or practice using the real tools or instruments rather than a specimen or a prosthesis to the real objects such as the body of tissues of an organism is one possible cause to lower the learner's motivation. Therefore, a need exists for a system and a method that can provide a high quality and reliable stereo AR images.

### SUMMARY

One of the objectives of the present invention is to provide a system for generating the AR images to solve the problem caused by lacking of the interaction and then improve or enhance the technique that of the traditional microscope device.

One of the objectives of the present invention is to provide another system for generating the AR images to solve the problem caused by lacking of the interaction and then improve or enhance the technique that of the traditional microscope device.

One of the objectives of the present invention is to provide a method for generating the AR images of an observed object to extend the fields or types of the AR applications.

One of the objectives of the present invention is to provide a microsurgery training system applying a stereoscopic video see-through technique to extend the fields of the AR techniques and the interaction.

One of the objectives of the present invention is to provide an electronic component assembly training and examining system applying a stereoscopic video see-through technique to extend the fields of the AR techniques and the interaction.

One of the objectives of the present invention is to provide an interactive object observing system applying a stereoscopic video see-through technique to extend the fields of the AR techniques and the interaction.

One of the objectives of the present invention is to provide a non-transitory computer readable storage medium storing the programs or firmware to improve the portability and integration.

One of the objectives of the present invention is to provide a computer application program using or installing in the system for generating the AR images.

One of the objectives of the present invention is to provide a system-on-chip (SoC) system to lower the cost of system establishment, simplify the control flow and achieve the system down sizing.

One of the objectives of the present invention is to provide a digital microscope module to achieve the modulization.

In order to achieve the objectives, a preferred embodiment of the system for generating the augmented reality (AR) images of the present invention includes a processing module and a digital microscope module having a vergence module and a plurality of camera units capturing an instant image of an observed object and transmitting to the processing module in responsive to a control signal. The observed object is tiny in its volume or mass and suitable to apply a microscopic or a vergence process by the function of the vergence module adjusting the corresponding or geometric relationship between a reflection mirror unit and the camera units in responsive to the control signals related to the user's motions or an automatic adjustment rule. The processing module configured to track and parse the user's motions to the observed object and generate the corresponding AR images, wherein if the user's motions includes a trigger of an interactive application including a switch of the display modes for the observed object or an activation of a real-time tutorial or sharing at least, the processing module further generates the AR images composed with/without an user interface (UI), icons, objects, video and/or information related to the interactive application respectively. Accordingly, user can obtain good user experience due to the retrieval of the real-time feedback and interaction.

In some embodiments, the system further includes a single-chip microcontroller for activating the digital microscope module in responsive to the control signals, and a positioning module configured to couple to the digital microscope module having the vergence module including a vergence controller unit and the reflecting mirror unit for moving in an operable space in responsive to the control signals. In addition, the user's motions includes that entering into or exiting from the operable space by using a simulation tool, user's hand or finger or a real surgical or experimental instrument operated by the user, approaching, touching, leaving, operating, installing or fixing partial or all of the object and/or changing the status of the operating or feature region. Accordingly, the blurring issue resulted from the insufficient vergence to the tiny observed object is dismiss.

In some embodiments, the system further includes an operable interface module configured or coupled to the processing module for selecting or performing the user's motions by the user and/or configured to have a operating parameter adjustment object and/or a display mode switching object, wherein the user's motions further include temporarily remove, transparent or disable the real-time tutorial or sharing and the related AR images with/without the virtual object for preventing the interference in responsive to a temporary disable mechanism. Moreover, the operating parameter adjustment object configured is provided for the user to adjust the focus, the ratio to zoom-in/-out, the distance to shift, the angle to rotate or the parameter value of a light source of the digital microscope module, and the display mode switching object configured is provided for the user to select the single or simultaneous display or arrangement of the AR images of the same or different objects, and the display modes is selected from the group of a single, a parallel and an array mode. Furthermore, the system further includes an evaluating module and/or an error alerting configured to generate or output an evaluating result, a unalignment response or a tip for trigger operation correspondingly when the AR imaged generated by the processing module is satisfied or unsatisfied to a preset requirement, or includes a feedback or community module configured to store, transmit or share the AR images, the evaluating result, the unalignment response or the tip for trigger operation.

In order to achieve the objectives, another preferred embodiment of the system for generating the augmented reality (AR) images of the present invention includes a processing module and a digital microscope module. The processing module configured to track and parse the user's motions, generate the corresponding control signals, receive the instant images having at least one object or the status of at least one operating or feature region that were retrieved in responsive to the user's motions or the control signals, process the instant images to generate at least one virtual object and the AR images overlapped with the virtual object, and wherein if the user's motions includes a trigger of an interactive application including a switch of the display modes for the object or an activation of a real-time tutorial or sharing at least, the processing module further generates the instant images transparent, solid or dynamic in part or on the whole, that of the interactive application is triggered or the AR images composed with or without an user interface (UI), icons, objects, video and/or information related to the interactive application before or after the overlapping, invoking or displaying respectively. In addition, the digital microscope module configured to comprise a vergence module and a plurality of camera units at least, wherein the camera units capture the instant images in responsive to the control signals and then transmit to the processing module, the object is tiny in its volume or mass and suitable to apply a microscopic or a vergence process for observing and interacting, and the vergence module adjust the corresponding or geometric relationship between a reflection mirror unit and the camera units in responsive to the control signals or an automatic adjustment rule.

In order to achieve the objective, a preferred embodiment of the method for generating the augmented reality (AR) images of an observed object which is tiny in the volume or mass and suitable to apply a microscopic and a vergence process of the present invention includes the steps of: tracking and parsing the user's motions to generate the corresponding control signals, wherein the user's motions includes a trigger of an interactive application including a switch of the display modes for the object or an activation of a real-time tutorial or sharing at least; generating and processing the instant images of the observed object which is processed in transparent, solid or dynamic in part or on the whole or that of the status of the operating or feature region after an interactive application is triggered to form at least one virtual object; and generating the AR images composed with an user interface (UI), icons, objects, video, information related to the interactive application and the virtual object before or after the overlapping, invoking or displaying respectively.

In some embodiments, the user's motions includes operating a positioning module, a simulation tool, user's hand or finger or a real surgical or experimental instrument to enter into or exit from an operable space, approach, touch, leave, operate, install or fix partial or all of the object or all of the object and/or change the status of the operating or feature region; removing, transparanting or disabling a real-time tutorial or sharing and the related AR images with/without the virtual object temporarily for preventing the interference in responsive to a temporary disable mechanism; and adjusting the focus, the ratio to zoom-in/-out, the distance to shift, the angle to rotate or the parameter value of a light source of the digital microscope module. Moreover, if the interactive application is a display mode switching, the method further includes the steps of: switching a display mode to a single, a parallel and an array mode to generate a single or simultaneous display or arrangement of the AR images of the same or different objects, and displaying the AR images to a display module configured as a head mounted display (HMD), stereo display or a flat display. Accordingly, the method of the present invention improves the effect and smoothness due to the prevention of the blocking of line of sight by tracking and predicting the user's motions and processing such as removing temporarily or changing the virtual object to transparent, solid or dynamic in part or on the whole or that of the status of the operating or feature region after an interactive application is triggered to form at least one virtual object.

In ordering to achieve objective, the microsurgery training system applying a stereoscopic video see-through technique, configuring the system for generating the augmented reality (AR) images of the present invention, is disclosed. The observed object is the real body or tissues of an tiny organism, a specimen or a prosthesis, and the stereoscopic video see-through technique is the technique that the digital microscope module captures the instant images of the observed object or the status of one of the operating or feature region for the processing module to form, overlap and output the virtual object to a display module synchronously for diminishing the alignment error or reducing the latency. On the other hand, the microsurgery training system can be used to perform the method for generating the augmented reality (AR) images of an observed object of the present invention as well.

In ordering to achieve objective, the electronic component assembly training and examining system applying a stereoscopic video see-through technique, configuring the system for generating the augmented reality (AR) images of the present invention, is disclosed. The observed objects is a circuit board for installing or fixing the electronic component, a medium or a electrical device, and the stereoscopic video see-through technique is the technique that the digital microscope module captures the instant images of the observed object or the status of one of the operating or feature region for the processing module to form, overlap and output the virtual object to a display module synchronously for diminishing the alignment error or reducing the latency. On the other hand, the microsurgery training system can be used to perform the method for generating the augmented reality (AR) images of an observed object of the present invention as well.

In ordering to achieve objective, the interactive object observing system applying a stereoscopic video see-through technique, configuring the system for generating the augmented reality (AR) images of the present invention, is disclosed. The observed objects is selected from the group of a tiny organism, a plant, a mineral, or an organic matter, an inorganic matter, a chemical element or a chemical compound, and the stereoscopic video see-through technique is the technique that the digital microscope module captures the instant images of the observed object or the status of one of the operating or feature region for the processing module to form, overlap and output the virtual object to a display module synchronously for diminishing the alignment error or reducing the latency. On the other hand, the microsurgery training system can be used to perform the method for generating the augmented reality (AR) images of an observed object of the present invention as well.

In ordering to achieve objective, the non-transitory computer readable storage medium storing the programs or firmware, wherein the programs or firmware loaded or assembly control or drive a system for generating the augmented reality (AR) images of the present invention, is disclosed. The programs or firmware includes a processing program or machine code and a digital microscope module program or machine code. The processing program or machine code for simulates the function of a processing module of the system for generating the augmented reality (AR) images, and the digital microscope module program or machine code simulates the function of the digital microscope module of the mentioned system.

In ordering to achieve objective, the computer application program using or installing in the system for generating the augmented reality (AR) images of the present invention, is disclosed. The computer application program includes a processing subroutine and a digital microscope subroutine, the processing subroutine for simulating the function of the processing module of the system for generating the augmented reality (AR) images, and digital microscope subroutine for simulating the function of the digital microscope module of the mentioned system.

In ordering to achieve objective, the system-on-chip (SoC) system, configuring a processing module of the system for generating the augmented reality (AR) images of the present invention, is disclosed.

In ordering to achieve objective, the digital microscope module, coupling or connecting to the processing module of the system for generating the augmented reality (AR) images of the present invention, a computer host or a portable electronics device configured, connected or coupled to the processing module.

In some embodiments, the parts of a vergence module of the digital microscope module is a beam splitting element for the camera units to receive the instant images having at least one object or the status of at least one operating or feature region induced and then reflected by the beam splitting element.

In another embodiments, the digital microscope module includes the beam splitting element configured between the vergence module and the camera units for the camera units to receive the instant images having at least one object or the status of at least one operating or feature region reflected, induced and then reflected again to the beam splitting element by the vergence module.

### BRIEF DESCRIPTION OF DRAWINGS

The aforementioned implementation of the present application as well as additional implementations will be more clearly understood as a result of the following detailed description of the various aspects of the application when taken in conjunction with the drawings.

FIG. 1 is a system functional block diagram illustrating the system for generating the AR images in accordance with the preferred embodiment of the present invention.

FIG. 2 is a schematic diagram illustrating the concept of vergence of the system for generating the AR images in accordance with the preferred embodiment of the present invention.

FIG. 3 is a block diagram illustrating the microscope module and the light source module of the system for generating the AR images in accordance with the preferred embodiment of the present invention.

FIG. 4A is a block diagram illustrating the microscope module, the positioning module and the light source module of the system for generating the AR images in accordance with the preferred embodiment of the present invention.

FIGS. 4B and 4C are the schematic diagrams illustrating the reflection mirror of the system for generating the AR images in accordance with the different preferred embodiments of the present invention.

FIG. 4D-4F are the schematic diagrams illustrating the vergence module, the beam splitting element and the operation of beam splitting of the digital microscope module in accordance with the different preferred embodiments of the present invention.

FIG. 5 is a block diagram illustrating the microscope module, the vergence module, the positioning module and the light source module of the system for generating the AR images in accordance with the preferred embodiment of the present invention.

FIGS. 6A and 6B are the block diagrams illustrating the operable interface module and the simulated element of the system for generating the AR images in accordance with the different preferred embodiments of the present invention.

FIG. 7 is a flowchart illustrating the performing of function of the processing module of the system for generating the AR images in accordance with the preferred embodiment of the present invention.

FIG. 8A-8D are the schematic diagrams illustrating the AR images of the microsurgery training system applying a stereoscopic video see-through technique in accordance with the different preferred embodiments of the present invention.

FIGS. 9A and 9B are the schematic diagrams illustrating the AR images of the electronic component assembly training and examining system applying a stereoscopic video see-through technique in accordance with the different preferred embodiments of the present invention.

FIGS. 10A and 10B are the schematic diagrams illustrating the AR images of the microsurgery training system applying a stereoscopic video see-through technique in accordance with the different preferred embodiments of the present invention.

### DETAILED DESCRIPTION

Reference will now be made in detail to embodiments, examples of which are illustrated in the accompanying drawings. In the following detailed description, numerous specific details are set forth in order to provide a thorough understanding of the subject matter presented herein. But it will be apparent to one skilled in the art that the subject matter may be practiced without these specific details. In other instances, well-known methods, procedures, components, and circuits have not been described in detail so as not to unnecessarily obscure aspects of the embodiments.

To promote an understanding of the objectives, technical solutions, and advantages of the present application, embodiments of the present application are further described in detail below with reference to the accompanying drawings.

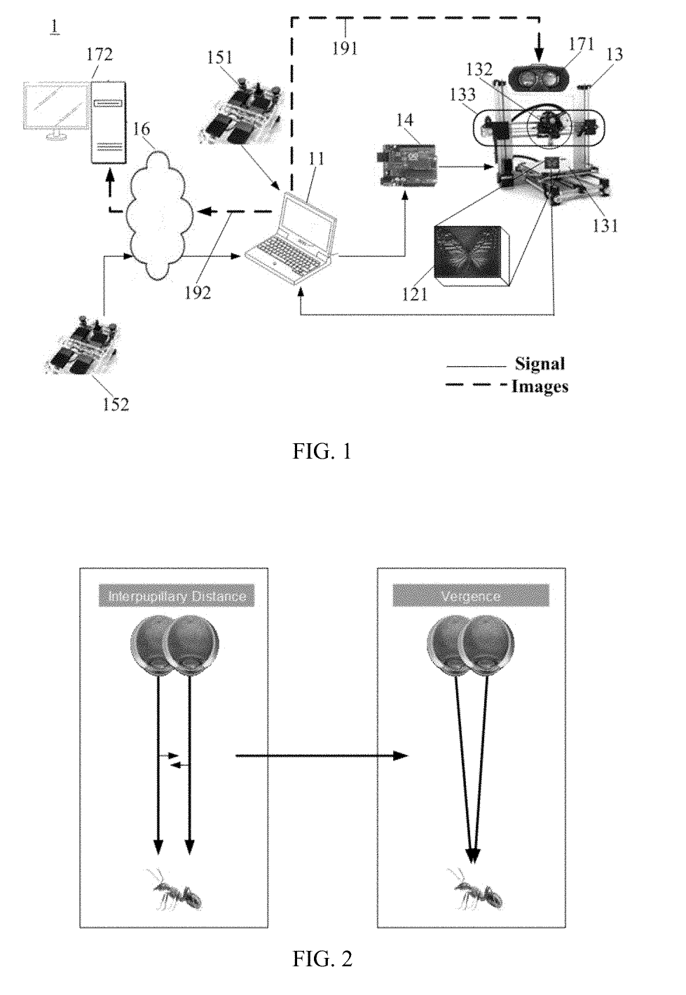

FIG. 1 is a system functional block diagram illustrating the system for generating the AR images in accordance with the preferred embodiment of the present invention. As shown in FIG. 1, the system for generating the AR images 1 includes a processing module (not shown in FIG. 1) coupling or connecting to a computer host or a portable electronics device 11, a positioning module 13, an operating platform 131, a digital microscope module 132, a single-chip microcontroller interface module 14, an operable interface module 151 and 152 and display module 171 and 172. Moreover, the computer host and the portable electronics device 11 may be either coupled or connected to the display module 171 for displaying the AR image 191, or coupled or connected to the display module 172 via network 16 for displaying the AR image 192. The display module 171 and 172 may be a head mounted display (HMD), s stereo display or a flat display for displaying the AR images or the stereo images, and the display module 172 may be coupled or connected to a terminal having calculating ability or a server for remote control. The single-chip microcontroller interface module 14 may be coupled or connected to the portable electronics device 11 or between the processing module and the digital microscope module 132. The positioning module 13, an operating platform 131 and the digital microscope module 132 can be coupled, connected or assembled together. The operating platform 131 provides a space for an user to place the real body or tissues of an tiny organism such as a butterfly in the embodiment, a specimen, a prosthesis, a circuit board, a medium or an electronic device as a observed object 121 to be observed. The positioning module 13 may be configured by the digital microscope module 132 and drive the mechanism or the element such as the motor in responsive to the control signals issued by the computer the portable electronics device 11.

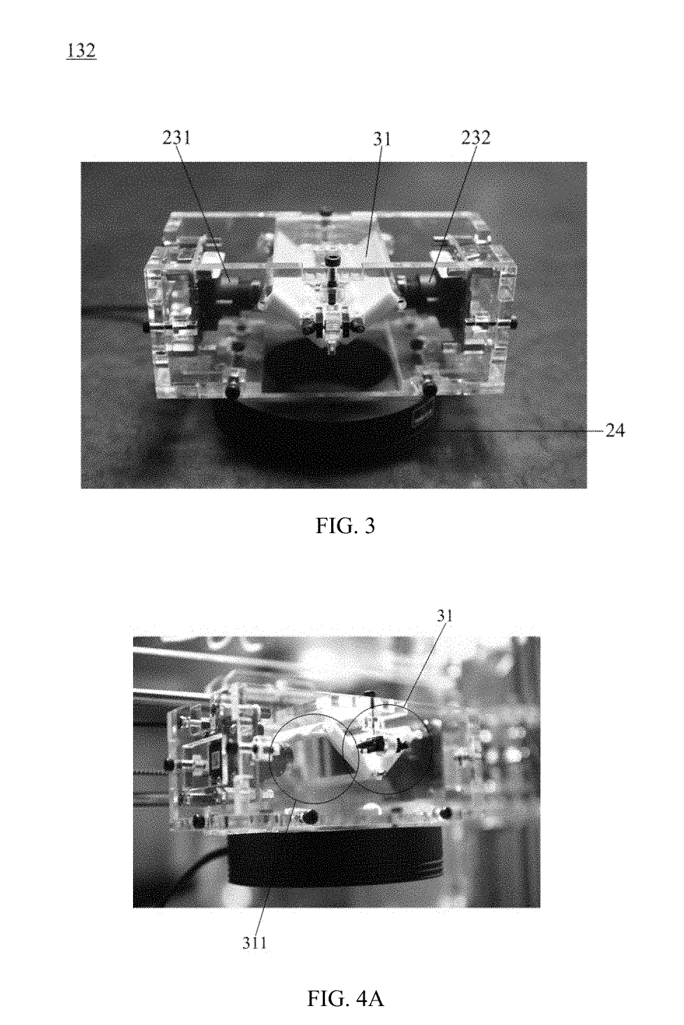

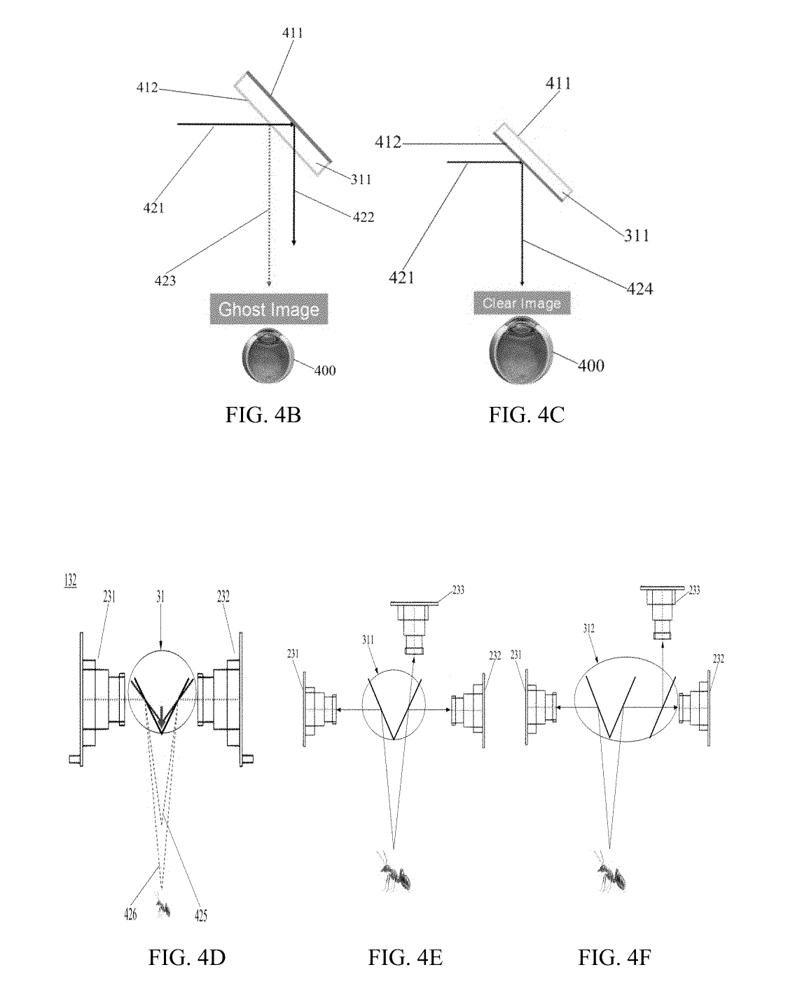

FIG. 2 is a schematic diagram illustrating the concept of vergence of the system for generating the AR images in accordance with the preferred embodiment of the present invention. FIG. 3 is a block diagram illustrating the microscope module and the light source module of the system for generating the AR images in accordance with the preferred embodiment of the present invention. FIG. 4A is a block diagram illustrating the microscope module, the positioning module and the light source module of the system for generating the AR images in accordance with the preferred embodiment of the present invention. FIGS. 4B and 4C are the schematic diagrams illustrating the reflection mirror of the system for generating the AR images in accordance with the different preferred embodiments of the present invention. It's noted that we select one unit or one set of reflection mirror as the beam splitting element as the preferred embodiment herein. As shown in the left side of FIG. 2, it depicts the issue of interpupillary distance of imaging for an user to observe the tiny object such as an ant, and it can be fixed by adjusting either or both line of sight of the camera in the vergence process as shown in the right side of FIG. 2. The embodiments shown in FIGS. 1,3 and 4A depict that the digital microscope module 132 includes two camera unit 231 and 232 capturing the instant image of the observed object which is tiny in its volume or mass and suitable to apply a microscopic and a vergence process performed by a vergency module 31 in responsive to the control signals related to the user's motions or an automatic adjustment rule.

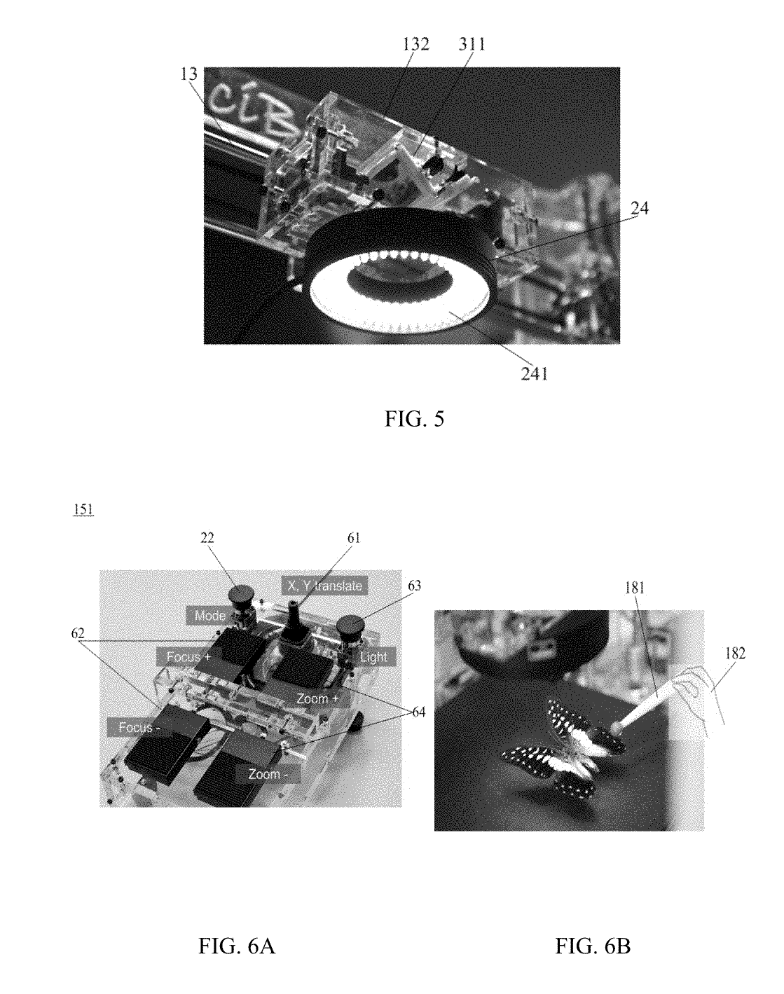

FIG. 4D-4F are the schematic diagrams illustrating the vergence module, the beam splitting element and the operation of beam splitting of the digital microscope module in accordance with the different preferred embodiments of the present invention. FIG. 5 is a block diagram illustrating the microscope module, the vergence module, the positioning module and the light source module of the system for generating the AR images in accordance with the preferred embodiment of the present invention. Referring to FIG. 4A-4F, the vergence module 31 includes a vergence controller unit adjusting the corresponding or geometric relationship between the reflection mirror unit 311 and the camera unit 231 and 232 in responsive to the control signals related to the user's motions or an automatic adjustment rule. The reflection mirror unit 311 with v-shaped in the embodiment can be adjusted to move in an operable space in responsive to the control signal, and the material, function or assembly mechanism such as using a hinge can be alternative designs or selection. The circular light source 24 with LED 241 is set for preventing the shadow. As shown in FIGS. 4B and 4C, the first side 411 and the second side 412 can be configured separately and performed a coating of the reflection mirror 311 to control the light and image 422-424 displaying to the user's eyes 400. Moreover, as shown in FIG. 4D-4F, the location of the camera unit 231-233 is adjustable in responsive to different types of the vergence module 31, the beam splitting element 311 and 312 such as a perpendicular reflection mirror and the application. In addition, as shown in FIG. 4D-4F, by observing the factors such as the reflection path, distance, inducing path, the light and the image 425 and 426, the design of capturing system or module affects the quality of the instant images and the AR images significantly.

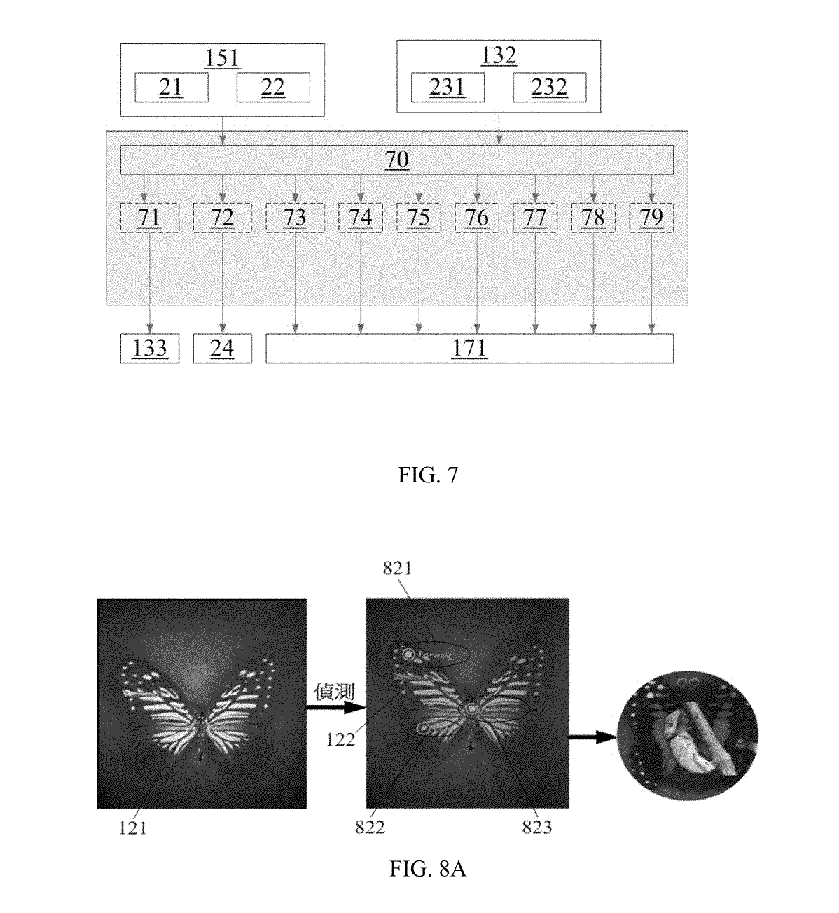

FIGS. 6A and 6B are the block diagrams illustrating the operable interface module and the simulated element of the system for generating the AR images in accordance with the different preferred embodiments of the present invention, and FIG. 7 is a flowchart illustrating the performing of function of the processing module of the system for generating the AR images in accordance with the preferred embodiment of the present invention. The processing module configured to track and parse the motions commands or instructions that of the user 70 and selected by the operable interface module 151 to generate the corresponding control signals to the light source 24 or the positioning module 133, receive the instant images having at least one object or the status of at least one operating or feature region that were retrieved or captured by the digital microscope module 132 and processed by the processing module to perform a image feature tracking 74, color detection 75, motion detection 76 in responsive to the user's motions or the control signals, process the instant images to generate at least one virtual object and the AR image 191 and 192 overlapped with the virtual object to the display module 171. In addition, the user's motions includes the types of: operating a simulation tool 181, user's hand or finger 182 or a real surgical or experimental instrument (not shown in the FIGs) to enter into or exit from an operable space, approach, touch, leave, operate, install or fix partial or all of the object or all of the object and/or change the status of the operating or feature region. Moreover, If the user's motions includes a trigger of an interactive application 77 including a switch of the display modes for the object or an activation of a real-time tutorial or sharing, the processing module further generates the instant images which is transparent, solid or dynamic in part or on the whole, that of the interactive application is triggered or the AR images composed with or without an user interface (UI), icons, objects, video and/or information related to the interactive application before or after the overlapping, invoking or displaying respectively. Furthermore, the processing module includes an evaluating module 78 and/or an error alerting module 79 configured to generate or output an evaluating result, a unalignment response such as a flash of light or beep or a tip for trigger operation correspondingly when the AR images generated by the processing module is satisfied or unsatisfied to a preset requirement, and includes a feedback or community module configured to store, transmit or share the AR images, the evaluating result, the unalignment response or the tip for trigger operation.

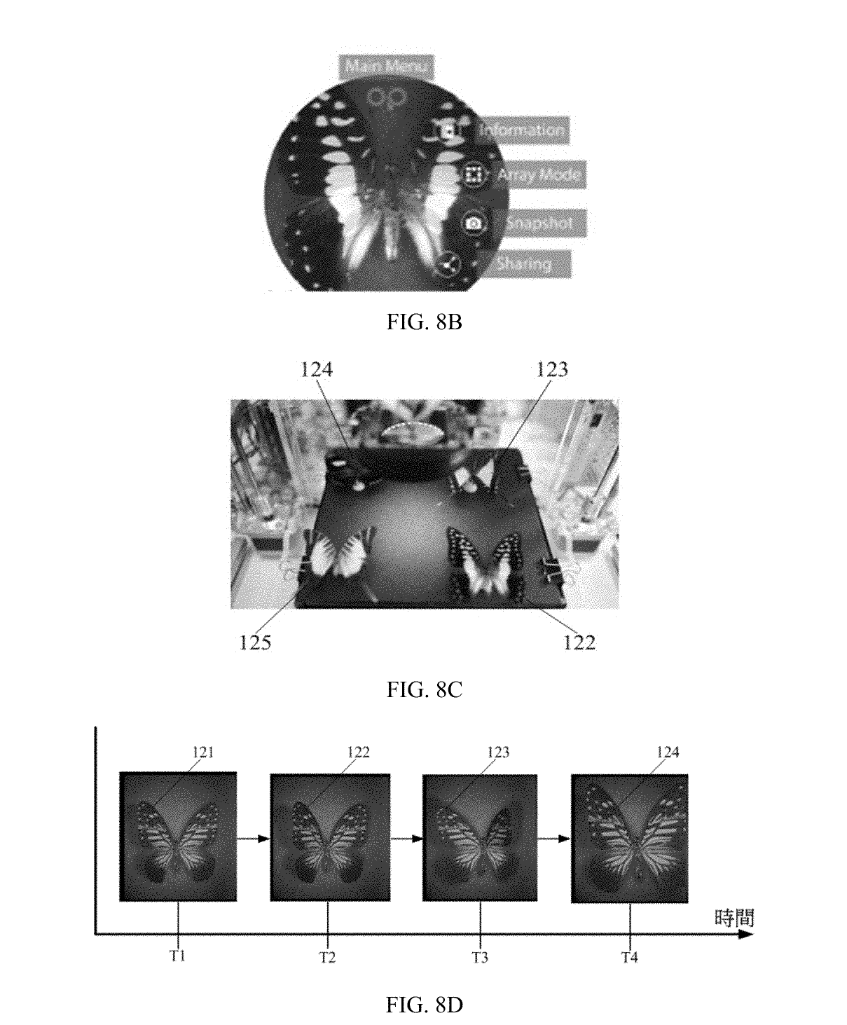

In some embodiments, the operable interface module 151 may be a tool such as a foot pedal as shown in FIG. 6A configured or coupled to the processing module for selecting or performing the user's motions by the user and/or configured to have a operating parameter adjustment object 61-64 and/or a display mode switching object 22, wherein the user's motions further include temporarily remove, change to transparent or disable the real-time tutorial or sharing and the related AR images with/without the virtual object for preventing the interference in responsive to a temporary disable mechanism. The operating parameter adjustment object 61-64 configured is provided for the user to adjust the focus, the ratio to zoom-in/-out 73, the distance to shift and the angle to rotate 71 or the parameter value of a light source 72 of the digital microscope module, and the display mode switching object 22 configured is provided for the user to select the single or simultaneous display or arrangement of the AR images of the same or different objects 122-125, and the display modes is selected from the group of a single, a parallel and an array mode (shown as FIG. 8C).

FIG. 7 is a flowchart illustrating the performing of function of the processing module of the system for generating the AR images in accordance with the preferred embodiment of the present invention. The method for generating the augmented reality (AR) images of an observed object, wherein the observed object is tiny in its volume or mass and suitable to apply a microscopic and a vergence process, the method comprising the steps of: tracking and parsing the user's motions to generate the corresponding control signals, wherein the user's motions includes a trigger of an interactive application including a switch of the display modes for the object or an activation of a real-time tutorial or sharing at least; generating and processing the instant images of the observed object which is processed to transparent, solid or dynamic in part or on the whole or that of the status of the operating or feature region after an interactive application is triggered to form at least one virtual object; and generating the AR images composed with an user interface (UI), icons, objects, video, information related to the interactive application and the virtual object before or after the overlapping, invoking or displaying respectively. Moreover, the user's motions includes of: operating a positioning module, a simulation tool 181, user's hand or finger 182 or a real surgical or experimental instrument to enter into or exit from an operable space, approach, touch, leave, operate, install or fix partial or all of the object or all of the object and/or change the status of the operating or feature region; removing, changing to transparent or disabling a real-time tutorial or sharing and the related AR images with/without the virtual object temporarily for preventing the interference in responsive to a temporary disable mechanism; and adjusting the focus, the ratio to zoom-in/-out, the distance to shift, the angle to rotate or the parameter value of a light source of the digital microscope module. In addition, if the interactive application is a display mode switching, the method further comprising the steps of: switching a display mode to a single, a parallel and an array mode to generate a single or simultaneous display or arrangement of the AR images of the same or different objects; and displaying the AR images to a display module configured as a head mounted display (HMD), s stereo display or a flat display.

The non-transitory computer readable storage medium storing the programs or firmware loaded, assembly control or drive the system for generating the augmented reality (AR) images is disclosed. The programs or firmware includes a processing program or machine code for simulating the function of a processing module of the system for generating the augmented reality (AR) images; and a digital microscope module program or machine code for simulating the function of the digital microscope module of the system for generating the augmented reality (AR) images.

The computer application program using or installing in a system for generating the augmented reality (AR) images is disclosed. The computer application program includes a processing subroutine for simulating the function of the processing module of the system for generating the augmented reality (AR) images; and a digital microscope subroutine for simulating the function of the digital microscope module of the system for generating the augmented reality (AR) images.

The system-on-chip (SoC) system, configuring a processing module of a system for generating the augmented reality (AR) images.

FIG. 8A-8D are the schematic diagrams illustrating the AR images of the microsurgery training system applying a stereoscopic video see-through technique in accordance with the different preferred embodiments of the present invention. The microsurgery training system applying a stereoscopic video see-through technique, configuring the system for generating the augmented reality (AR) images, wherein the observed object such as the butterfly 121-125 is the real body or tissues of an tiny organism, a specimen or a prosthesis, and the stereoscopic video see-through technique is the technique that the digital microscope module captures the instant images during time period T1-T4 of the observed object or the status of one of the operating or feature region 821-823 for the processing module to form, overlap and output the virtual object to a display module synchronously for diminishing the alignment error or reducing the latency, and then extend the application fields such as display the static image to the dynamic one. Moreover, as shown in the right-upward side of FIG. 8A, it depicts that the symbol of manual and the virtual object illustrating the observed object or samples such as a butterfly larvae overlapped, and the corresponding icons or objects including the manual, information, array display mode, snapshot, sharing to the social networks is shown in FIG. 8B. Accordingly, With this application, the user can get multimedia information such as texts, photos or videos while observing the samples without disruptions, and if one who is dissecting small animals, he/she can reach the atlas from the HMD by simply waving the knife or forceps in the corner.

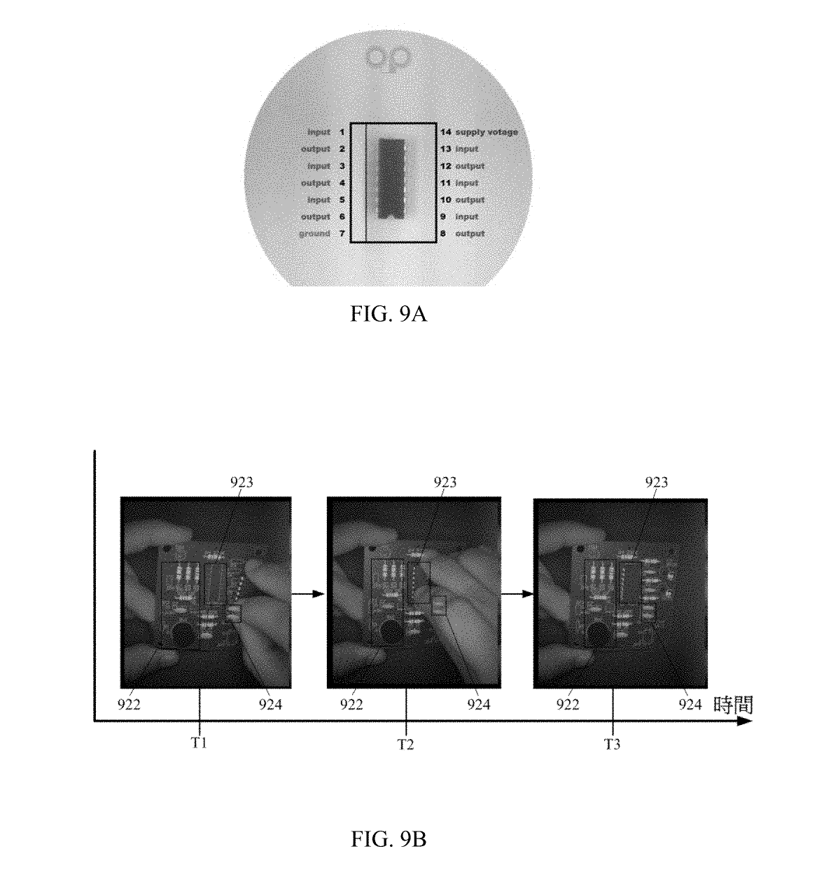

FIGS. 9A and 9B are the schematic diagrams illustrating the AR images of the electronic component assembly training and examining system applying a stereoscopic video see-through technique in accordance with the different preferred embodiments of the present invention. As shown in FIG. 9B, the observed objects is a printed circuit board (PCB) for installing or fixing the electronic component such as a resistor or a capacitor, a medium or a electrical device, and the stereoscopic video see-through technique is the technique that the digital microscope module captures the instant images of the observed object or the status of one of the operating or feature region 922-924 for the processing module from the time period T1-T3 to form, overlap and output the virtual object to a display module synchronously during the time period T1-T3 for diminishing the alignment error or reducing the latency. In other words, the virtual objects of all of the layout of electronic element to be fixed or assembled are visible in the beginning of the assembly or training process, and they are removed, changed to transparent or disabled with a real-time tutorial or sharing and the related AR images with/without the virtual object temporarily and automatically for preventing the interference in responsive to a temporary disable mechanism. As shown in FIG. 9A, the observed object is an IC having the pins for transmitting and receiving different data or signals, and thus it's not required for the user to leave away or to be interrupted frequently for the purposes such as seeking the data or parameter value in the user manual according to the present invention.

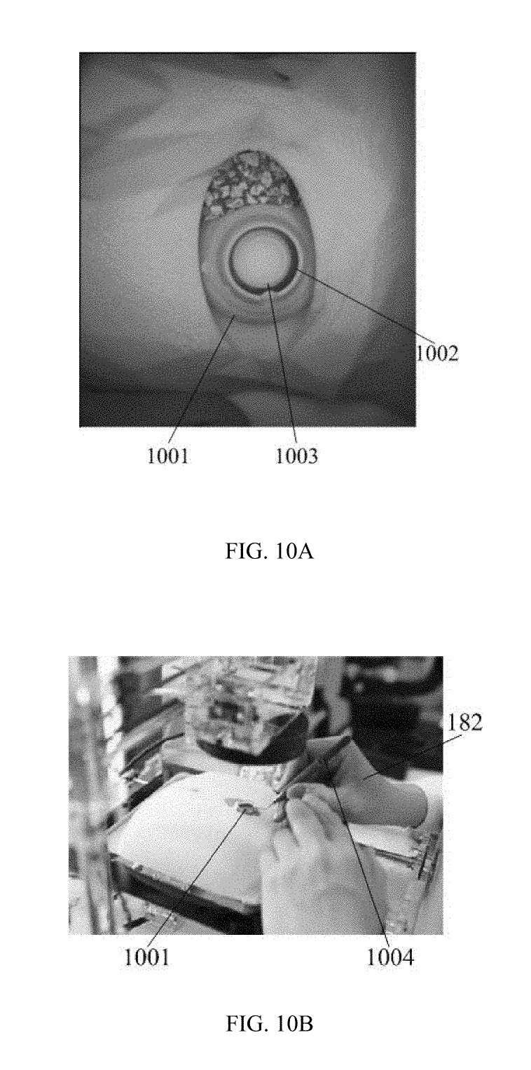

FIGS. 10A and 10B are the schematic diagrams illustrating the AR images of the microsurgery training system applying a stereoscopic video see-through technique in accordance with the different preferred embodiments of the present invention. The types of the microsurgery includes but not limited to the surgery operation to Cataract, Retina, Macula and Cornea, and the system supporting the operation or practice using the real tools or instruments such as a capsulorhexis forceps 1004, and the observed object is the real body or tissues of an tiny organism, a specimen or a prosthesis. The stereoscopic video see-through technique is the technique that the digital microscope module captures the instant images of the observed object such as an artificial eye model 1001 or the status of one of the operating or feature region, illustrated as the region 1002, for the processing module to form, overlap and output the virtual object 1003 as a capsulorhexis maker or real-time guidance for the surgery to a display module synchronously for diminishing the alignment error or reducing the latency. Moreover, the user can use a probe or the real surgery instrument to performance the microsurgery training. Besides, on the other hand, the microsurgery training system can be used to perform the method for generating the augmented reality (AR) images of an observed object of the present invention as well.

The foregoing description, for purpose of explanation, has been described with reference to specific embodiments. However, the illustrative discussions above are not intended to be exhaustive or to limit the present application to the precise forms disclosed. Many modifications and variations are possible in view of the above teachings. The embodiments were chosen and described in order to best explain the principles of the present application and its practical applications, to thereby enable others skilled in the art to best utilize the present application and various embodiments with various modifications as are suited to the particular use contemplated.

While particular embodiments are described above, it will be understood it is not intended to limit the present application to these particular embodiments. On the contrary, the present application includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

1. A system for generating the augmented reality (AR) images, comprising:
a processing module configured to track and parse the user's motions to an observed object and generate the corresponding AR images, wherein if the user's motions includes a trigger of an interactive application including a switch of the display modes for the observed object or an activation of a real-time tutorial or sharing at least, the processing module further generates the AR images composed with/without an user interface (UI), icons, objects, video and/or information related to the interactive application respectively; and
a digital microscope module configured to comprise a vergence module and a plurality of camera units at least, wherein the camera units capture an instant image and then transmit to the processing module, the observed object is tiny in its volume or mass and suitable to apply a microscopic or a vergence process by the function of the vergence module adjusting the corresponding or geometric relationship between a reflection mirror unit and the camera units in responsive to the control signals related to the user's motions or an automatic adjustment rule.

2. The system of claim 1, further comprising:
a single-chip microcontroller interface module configured to/between the processing module and the digital microscope module or coupled to the processing module for activating the digital microscope module in responsive to the control signals.

3. The system of claim 2, further comprising:
a positioning module configured to or couple to the digital microscope module wherein the vergence module further comprises a vergence controller unit and the reflecting mirror unit for moving in an operable space in responsive to the control signal, and the user's motions comprises that entering into or exiting from the operable space by using a simulation tool, user's hand or finger or a real surgical or experimental instrument operated by the user, approaching, touching, leaving, operating, installing or fixing partial or all of the object and/or changing the status of the operating or feature region.

4. The system of claim 1, further comprising:
an operable interface module configured or coupled to the processing module for selecting or performing the user's motions by the user and/or configured to have a operating parameter adjustment object and/or a display mode switching object, wherein the user's motions further include temporarily remove, change to transparent or disable the real-time tutorial or sharing and the related AR images with/without the virtual object for preventing the interference in responsive to a temporary disable mechanism.

5. The system of claim 4, wherein the operating parameter adjustment object configured is provided for the user to adjust the focus, the ratio to zoom-in/-out, the distance to shift and the angle to rotate or the parameter value of a light source of the digital microscope module, and the display mode switching object configured is provided for the user to select the single or simultaneous display or arrangement of the AR images of the same or different objects, and the display modes is selected from the group of a single, a parallel and an array mode.

6. The system of claim 1, further comprising:
an evaluating module and/or an error alerting module configured to generate or output an evaluating result, a unalignment response or a tip for trigger operation correspondingly when the AR images generated by the processing module is satisfied or unsatisfied to a preset requirement.

7. The system of claim 6, further comprising:
a feedback or community module configured to store, transmit or share the AR images, the evaluating result, the unalignment response or the tip for trigger operation.

8. A system for generating the augmented reality (AR) images, comprising:
a processing module configured to track and parse the user's motions, generate the corresponding control signals, receive the instant images having at least one object or the status of at least one operating or feature region that were retrieved in responsive to the user's motions or the control signals, process the instant images to generate at least one virtual object and the AR images overlapped with the virtual object, and wherein if the user's motions includes a trigger of an interactive application including a switch of the display modes for the object or an activation of a real-time tutorial or sharing at least, the processing module further generates the instant images which is transparent, solid or dynamic in part or on the whole, that of the interactive application is triggered or the AR images composed with or without an user interface (UI), icons, objects, video and/or information related to the interactive application before or after the overlapping, invoking or displaying respectively; and
a digital microscope module configured to comprise a vergence module and a plurality of camera units at least, wherein the camera units capture the instant images in responsive to the control signals and then transmit to the processing module, the object is tiny in its volume or mass and suitable to apply a microscopic or a vergence process for observing and interacting, and the vergence module adjust the corresponding or geometric relationship between a reflection mirror unit and the camera units in responsive to the control signals or an automatic adjustment rule.

9. A method for generating the augmented reality (AR) images of an observed object, wherein the observed object is tiny in its volume or mass and suitable to apply a microscopic and a vergence process, the method comprising the steps of:
tracking and parsing the user's motions to generate the corresponding control signals, wherein the user's motions includes a trigger of an interactive application including a switch of the display modes for the object or an activation of a real-time tutorial or sharing at least;
generating and processing the instant images of the observed object which is processed to transparent, solid or dynamic in part or on the whole or that of the status of the operating or feature region after an interactive application is triggered to form at least one virtual object; and
generating the AR images composed with an user interface (UI), icons, objects, video, information related to the interactive application and the virtual object before or after the overlapping, invoking or displaying respectively.

10. The method of claim 9, wherein the user's motions comprising:
operating a positioning module, a simulation tool, user's hand or finger or a real surgical or experimental instrument to enter into or exit from an operable space, approach, touch, leave, operate, install or fix partial or all of the object or all of the object and/or change the status of the operating or feature region;
removing, changing to transparent or disabling a real-time tutorial or sharing and the related AR images with/without the virtual object temporarily for preventing the interference in responsive to a temporary disable mechanism; and
adjusting the focus, the ratio to zoom-in/-out, the distance to shift, the angle to rotate or the parameter value of a light source of the digital microscope module.

11. The method of claim 9, wherein if the interactive application is a display mode switching, the method further comprising the steps of:
switching a display mode to a single, a parallel and an array mode to generate a single or simultaneous display or arrangement of the AR images of the same or different objects; and
displaying the AR images to a display module configured as a head mounted display (HMD), s stereo display or a flat display.

12. A microsurgery training system applying a stereoscopic video see-through technique, configuring a system for generating the augmented reality (AR) images, wherein the observed object is the real body or tissues of a tiny organism, a specimen or a prosthesis, and the stereoscopic video see-through technique is the technique that the digital microscope module captures the instant images of the observed object or the status of one of the operating or feature region for the processing module to form, overlap and output the virtual object to a display module synchronously for diminishing the alignment error or reducing the latency.

13. An electronic component assembly training and examining system applying a stereoscopic video see-through technique, configuring a system for generating the augmented reality (AR) images, wherein the observed objects is a circuit board for installing or fixing the electronic component, a medium or a electrical device, and the stereoscopic video see-through technique is the technique that the digital microscope module captures the instant images of the observed object or the status of one of the operating or feature region for the processing module to form, overlap and output the virtual object to a display module synchronously for diminishing the alignment error or reducing the latency.

14. An interactive object observing system applying a stereoscopic video see-through technique, configuring a system for generating the augmented reality (AR) images, wherein the observed objects is selected from the group of a tiny organism, a plant, a mineral, or an organic matter, an inorganic matter, a chemical element or a chemical compound, and the stereoscopic video see-through technique is the technique that the digital microscope module captures the instant images of the observed object or the status of one of the operating or feature region for the processing module to form, overlap and output the virtual object to a display module synchronously for diminishing the alignment error or reducing the latency.

15. A non-transitory computer readable storage medium storing the programs or firmware, wherein the programs or firmware loaded or assembly control or drive a system for generating the augmented reality (AR) images, and the programs or firmware comprising:
a processing program or machine code for simulating the function of a processing module of the system for generating the augmented reality (AR) images; and
a digital microscope module program or machine code for simulating the function of the digital microscope module of the system for generating the augmented reality (AR) images.

16. A computer application program using or installing in a system for generating the augmented reality (AR) images, comprising:
a processing subroutine for simulating the function of the processing module of the system for generating the augmented reality (AR) images; and
a digital microscope subroutine for simulating the function of the digital microscope module of the system for generating the augmented reality (AR) images.

17. A system-on-chip (SoC) system, configuring a processing module of a system for generating the augmented reality (AR) images.

18. A digital microscope module, coupling or connecting to a processing module of a system for generating the augmented reality (AR) images, a computer host or a portable electronic device configured, connected or coupled to the processing module.

19. The digital microscope module of claim 18, wherein the parts of the vergence module is a beam splitting element for the camera units to receive the instant images having at least one object or the status of at least one operating or feature region induced and then reflected by the beam splitting element.

20. The digital microscope module of claim 18, further comprising:
A beam splitting element configured between the vergence module and the camera units for the camera units to receive the instant images having at least one object or the status of at least one operating or feature region reflected, induced and then reflected again to the beam splitting element by the vergence module.
